(19) United States
(12) Patent Application Publication
(10) Pub. No.: US 2026/0109405 A1
(43) Pub. Date: Apr. 23, 2026

(54) VEHICLE BODY STRUCTURE

(71) Applicant: TOYOTA JIDOSHA KABUSHIKI KAISHA, Toyota-shi (JP)

(72) Inventor: Naoki IKUHARA, Kariya-shi (JP)

(73) Assignee: TOYOTA JIDOSHA KABUSHIKI KAISHA, Toyota-shi (JP)

(21) Appl. No.: 19/272,316

(22) Filed: Jul. 17, 2025

(30) Foreign Application Priority Data
Oct. 22, 2024 (JP) 2024-185694

(51) Int. Cl. B62D 25/14

(52) U.S. Cl. CPC B62D 25/14

(57) ABSTRACT

A vehicle body structure includes a vehicle body front portion, and a vehicle body component that includes a dash panel portion configured to separate an interior space of a vehicle cabin from a front compartment that is an exterior space of the vehicle cabin and a cowl portion provided integrally with the dash panel portion on an upper side of the dash panel portion in a vehicle up-down direction, in which the vehicle body component is manufactured by die-casting.

### CROSS-REFERENCE TO RELATED APPLICATION

This application claims priority to Japanese Patent Application No. 2024-185694 filed on Oct. 22, 2024. The disclosure of the above-identified application, including the specification, drawings, and claims, is incorporated by reference herein in its entirety.

### BACKGROUND

### 1. Technical Field

The present disclosure relates to a vehicle body structure.

### 2. Description of Related Art

Japanese Unexamined Patent Application Publication No. 2009-113568 (JP 2009-113568 A) discloses a front structure of a vehicle. The front structure of the vehicle includes a cowl that is disposed along a lower end of a windshield of the vehicle and that extends in a vehicle width direction, and a dash panel that is coupled to a lower portion of the cowl and that separates a vehicle cabin side from an engine compartment side. In the structure, the dash panel having a plate shape is secured to an outside of a front lower side wall of the cowl by spot welding at several appropriate locations.

### SUMMARY

In the structure disclosed in JP 2009-113568 A, the dash panel and the cowl are separate members. In such a structure, a watertight sealing material for sealing between the dash panel and the cowl is needed to prevent water from entering a vehicle cabin through a gap between the dash panel and the cowl. However, when the watertight sealing material is provided, the number of parts may increase and the structure may be complicated.

The present disclosure has been made in view of the above-described problems, and an object of the present disclosure is to obtain a vehicle body structure that enables reduction of the number of parts and simplification of the structure.

A vehicle body structure according to a first aspect of the present disclosure includes a vehicle body front portion and a vehicle body component that includes a dash panel portion and a cowl portion. The dash panel portion is configured to separate a vehicle cabin from a front compartment. The cowl portion is provided integrally with the dash panel portion on an upper side of the dash panel portion in a vehicle up-down direction. The vehicle body component is attached to the vehicle body front portion.

In the vehicle body structure according to the first aspect of the present disclosure, the dash panel portion and the cowl portion are integrally provided. As a result, a watertight sealing material for sealing between the dash panel portion and the cowl portion can be omitted. Therefore, the number of parts can be reduced. In addition, the structure can be simplified.

In addition, since the dash panel portion and the cowl portion are integrally provided, the dash panel portion and the cowl portion can be attached to the vehicle body front portion in one step. Therefore, the number of attachment steps can be reduced compared to a case where each of the dash panel portion and the cowl portion is attached to the vehicle body front portion, as in a case where the dash panel portion and the cowl portion are separate bodies. Therefore, an attaching operation can be facilitated.

In the vehicle body structure according to the first aspect of the present disclosure, the vehicle body component may be made of resin.

In the vehicle body structure, the vehicle body component may be made of resin. By forming the vehicle body component with resin having favorable processability as described above, a degree of freedom in shape and plate thickness of the cowl portion can be improved. Therefore, the cowl portion can be easily configured to have a structure designed to absorb the collision energy effectively. Therefore, for example, even in a case where a pedestrian's head collides with the cowl portion, the impact received by the pedestrian's head can be reduced.

In the vehicle body structure according to the first aspect of the present disclosure, the vehicle body component may be made of resin.

In the vehicle body structure, the vehicle body component may be manufactured by die-casting. As a result, the roll rigidity of the vehicle body component can be improved, and the roll rigidity of the entirety of the vehicle body structure can be improved.

In the vehicle body structure according to the first aspect of the present disclosure, the vehicle body front portion may be manufactured by die-casting.

In the vehicle body structure, the vehicle body front portion may be manufactured by die-casting. As a result, the roll rigidity of the vehicle body front portion can be improved, and the roll rigidity of the entirety of the vehicle body structure can be improved.

As described above, the vehicle body structure according to the present disclosure has an excellent effect of reducing the number of parts and simplifying the structure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view showing a vehicle body front portion of a vehicle body structure according to an embodiment;

FIG. 2 is a perspective view showing a vehicle body component of the vehicle body structure according to the embodiment;

FIG. 3 is a front view showing the vehicle body component of the vehicle body structure according to the embodiment; and

FIG. 4 is a side view showing the vehicle body component of the vehicle body structure according to the embodiment.

### DETAILED DESCRIPTION OF EMBODIMENTS

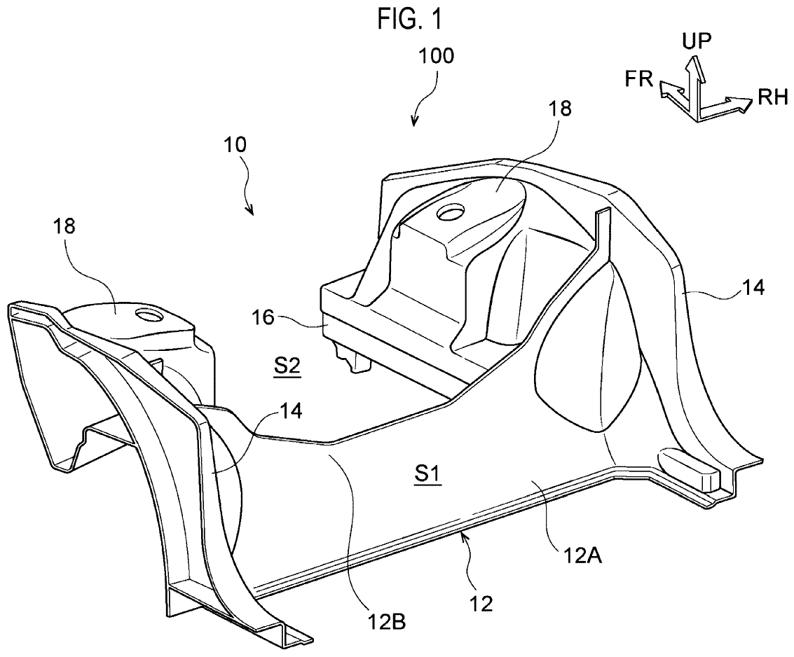

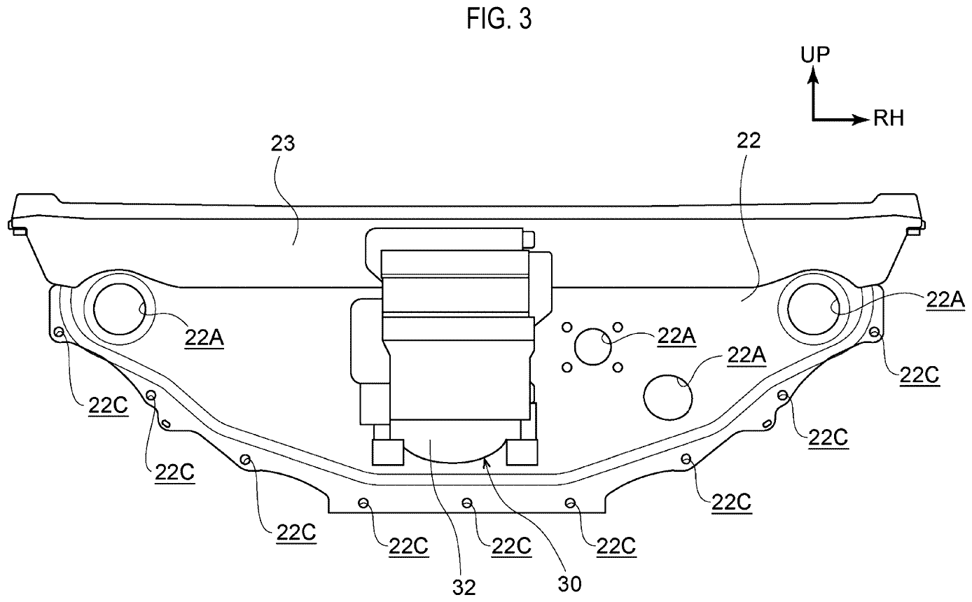

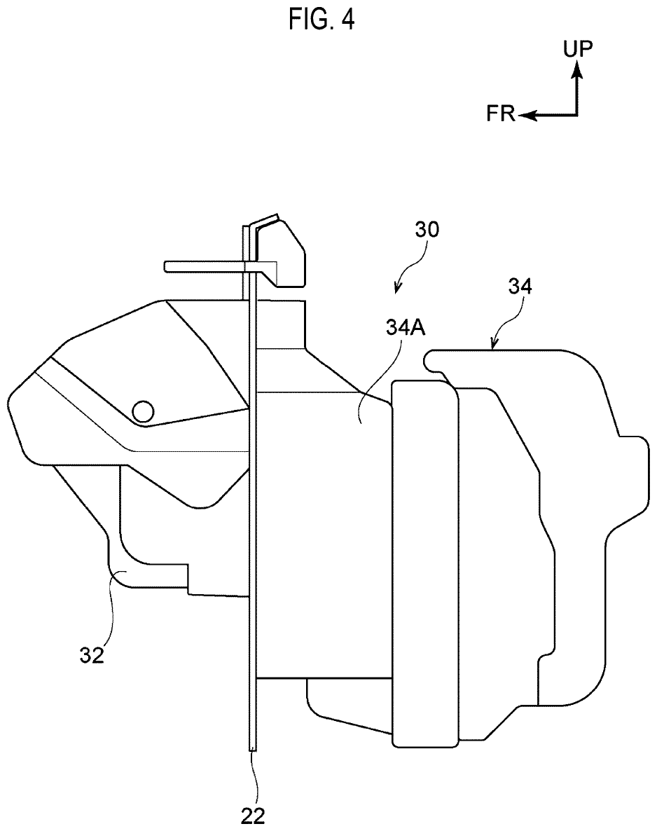

Hereinafter, an embodiment of a vehicle body structure 100 according to the present disclosure will be described with reference to FIGS. 1 to 4. In addition, an arrow FR shown in each of the drawings as appropriate indicates a vehicle forward direction, that is, a front side in a vehicle front-rear direction, an arrow RH indicates a vehicle rightward direction, that is, a right side in a vehicle width direction, and an arrow UP indicates a vehicle upward direction, that is, an upper side in a vehicle up-down direction. In the following description, a front-rear direction, a width direction, and an up-down direction represent the vehicle front-rear direction, the vehicle width direction, and the vehicle up-down direction, respectively. In addition, a right-left direction means a right-left direction when the vehicle is facing forward.

### Vehicle

A vehicle to which the vehicle body structure 100 according to the present embodiment is applied is, for example, a battery-powered electrified vehicle (battery electric vehicle (BEV)). The vehicle to which the vehicle body structure 100 according to the present embodiment is applicable is not limited to the BEV. For example, the vehicle body structure 100 according to the present embodiment may be applied to a fuel cell electric vehicle or the like.

### Vehicle Body Structure

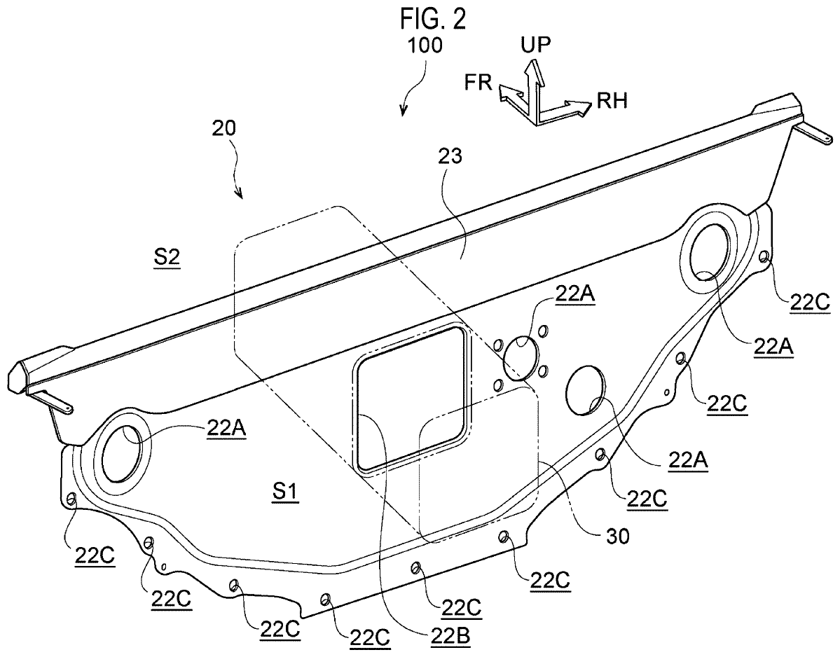

The vehicle body structure 100 according to the present embodiment is provided in a front portion of the vehicle. As shown in FIGS. 1 and 2, the vehicle body structure 100 includes a vehicle body front portion 10 and a vehicle body component 20 attached to the vehicle body front portion 10.

### Vehicle Body Front Portion

The vehicle body front portion 10 is a member that serves as a framework of a vehicle front portion. As shown in FIG. 1, the vehicle body front portion 10 includes a dash portion 12, a front pillar portion 14, a front side member portion 16, and a suspension tower portion 18. In addition, the vehicle body front portion 10 is manufactured by aluminum die-casting, and the dash portion 12, the front pillar portion 14, the front side member portion 16, and the suspension tower portion 18 are integrally formed.

The dash portion 12 is disposed at a front portion and a lower portion of the vehicle. The dash portion 12 separates an interior space S1 that is an inside of a vehicle cabin from a front compartment S2 that is an outside of the vehicle cabin. In detail, the dash portion 12 separates a lower portion of the interior space S1 from a lower portion of the front compartment S2.

A lower portion surface of the dash portion 12 on a vehicle rear side is an inclined surface 12A of which an upper side is positioned closer to a vehicle front side than a lower side. The inclined surface 12A is positioned below an instrument panel (not shown). An upper portion surface of the dash portion 12 on the vehicle rear side is a vertical surface 12B that extends substantially vertically in the vehicle up-down direction and in the vehicle width direction.

The front pillar portion 14 is connected to each of both ends of the dash portion 12 in the vehicle width direction, and a pair of the right and left front pillar portions 14 extends in the vehicle up-down direction. Specifically, a lower portion of the front pillar portion 14 extends in the vehicle front-rear direction, and a rocker (not shown) that is a framework member is connected to a rear end of the front pillar portion 14.

The front pillar portion 14 obliquely extends from its rear end to a vehicle upper side and the vehicle front side, and is configured to transmit a load acting on the vehicle body front portion 10 in the vehicle up-down direction.

A pair of the right and left front side member portions 16 is extended from both ends of the dash portion 12 in the vehicle width direction to the vehicle front side. The front side member portion 16 extends in the vehicle front-rear direction, and is configured to transmit a load input from the vehicle front side to the vehicle rear side.

The suspension tower portion 18 is provided on an outer side of each of the right and left front side member portions 16 in the vehicle width direction. The suspension tower portion 18 is positioned on the vehicle upper side with respect to the front side member portion 16, and is configured in a shape capable of supporting a suspension (not shown).

### Vehicle Body Component

The vehicle body component 20 is attached to the vehicle body front portion 10. As shown in FIG. 2, the vehicle body component 20 includes a dash panel portion 22, a cowl portion 23 provided on an upper side of the dash panel portion 22, and an air conditioning device (heating, ventilation, and air conditioning (HVAC)) 30 that penetrates the dash panel portion 22 in the vehicle front-rear direction. In FIG. 2, for ease of illustration, the air conditioning device 30 is shown by imaginary lines and is also shown in a schematic manner.

The vehicle body component 20 is modularized. That is, the vehicle body component 20 can be transported in a state where parts constituting the vehicle body component 20 are integrated. In addition, the vehicle body component 20 can be attached to the vehicle body front portion 10 in an integrated state.

The dash panel portion 22 is disposed in the front portion of the vehicle. The dash panel portion 22 is provided on the upper side of the dash portion 12. The dash panel portion 22 is a plate-shaped member and is disposed such that a plate surface is a surface including the vehicle up-down direction and the vehicle width direction. The dash panel portion 22 separates the interior space S1 of the vehicle cabin from a front compartment S2.

A plurality of through-holes 22A penetrating in a plate thickness direction (in the present embodiment, the vehicle front-rear direction) is formed in the dash panel portion 22. In addition, an air conditioning device through-hole 22B, through which the air conditioning device 30 passes, is formed at the center of the dash panel portion 22 in the vehicle width direction.

A plurality of bolt through-holes 22C is formed in a lower portion of the dash panel portion 22. The bolt through-holes 22C are arranged at predetermined intervals along a lower edge of the dash panel portion 22. The dash panel portion 22 is fixed to the dash portion 12 of the vehicle body front portion 10 by bolts (not shown) that pass through the bolt through-holes 22C.

The cowl portion 23 is provided on the upper side of the dash panel portion 22. The cowl portion 23 extends along the vehicle width direction.

The dash panel portion 22 and the cowl portion 23 are integrated. A member obtained by integrating the dash panel portion 22 and the cowl portion 23 may be made of resin or metal. In addition, the dash panel portion 22 and the cowl portion 23 may be integrally formed by injection molding or aluminum die-casting. In addition, the dash panel portion 22 and the cowl portion 23 may be manufactured separately and then fixed to each other by welding or the like.

As shown in FIGS. 2 to 4, the air conditioning device 30 is attached to the dash panel portion 22. The air conditioning device 30 includes a duct portion 32 provided on the front compartment S2 side and a temperature adjustment portion 34 provided on the interior space S1 side.

The duct portion 32 is a cylindrical member that extends in the vehicle front-rear direction, and is provided with an internal air flow path through which air flows. An opening (not shown) for introducing outside air is provided at an end of the duct portion 32 on the vehicle front side. In addition, an end of the duct portion 32 on the vehicle rear side is connected to an end of the temperature adjustment portion 34 on the front side. The duct portion 32 guides the air introduced from the opening provided at the end on the front side to the temperature adjustment portion 34.

The temperature adjustment portion 34 has a housing 34A that serves as an outer shell, a heater (not shown) housed in the housing 34A, and an evaporator (not shown) housed in the housing 34A. The temperature adjustment portion 34 receives the air introduced from the duct portion 32 into the housing 34A. The temperature adjustment portion 34 adjusts a temperature of the air introduced into the housing 34A using a heater and an evaporator that constitutes a part of a refrigeration cycle, and discharges the air from the housing 34A to the interior space S1 of the vehicle cabin. The method by which the temperature adjustment portion 34 adjusts the temperature of the air is not limited to a specific method, and may be, for example, a method of adjusting the temperature of the air by adjusting the amount of air sent to the heater and the amount of air sent to the evaporator.

### Manufacturing Method

A method of manufacturing the vehicle body structure 100 will be described. When manufacturing the vehicle body structure 100, the vehicle body front portion 10 and the vehicle body component 20 are manufactured separately. Then, the vehicle body component 20 is attached to the vehicle body front portion 10.

A factory where the vehicle body component 20 is manufactured and a factory where the vehicle body component 20 is attached to the vehicle body front portion 10 may be different factories. That is, the vehicle body component 20 may be assembled and modularized in a first factory, the vehicle body component 20 in a modularized state may be transported to a second factory, and the vehicle body component 20 may be attached to the vehicle body front portion 10 in the second factory.

### Action and Effect

According to the present embodiment, the following actions and effects can be obtained.

In the vehicle body structure 100 according to the present embodiment, the dash panel portion 22 and the cowl portion 23 are integrally provided. As a result, a watertight sealing material for sealing between the dash panel portion 22 and the cowl portion 23 can be omitted. Therefore, the number of parts can be reduced. In addition, the structure can be simplified.

In addition, the vehicle body component 20 including the dash panel portion 22, the cowl portion 23, and the air conditioning device 30 is modularized. Therefore, in one step of attaching the vehicle body component 20 to the vehicle body front portion 10, the parts (such as the dash panel portion 22, the cowl portion 23, and the air conditioning device 30) included in the vehicle body component 20 can be attached to the vehicle body front portion 10. Therefore, the number of steps can be reduced compared to a case where the parts included in the vehicle body component 20 are separate bodies. Therefore, the operation of attaching each part to the vehicle body front portion 10 can be facilitated.

In addition, for example, in a case where the cowl portion 23 and the dash panel portion 22 are separately provided, the cowl portion 23 may be attached to the vehicle body front portion 10 before the dash panel portion 22 is attached. In this case, when the dash panel portion 22 is attached to the vehicle body front portion 10, the cowl portion 23 and the dash panel portion 22 may interfere with each other, and thus the attaching operation may be complicated.

On the other hand, in the present embodiment, since the dash panel portion 22 and the cowl portion 23 are modularized, the dash panel portion 22 and the cowl portion 23 can be attached to the vehicle body front portion 10 simultaneously. Therefore, the attaching work can be simplified.

In addition, in a case where the cowl portion 23 is made of resin, a degree of freedom in shape and plate thickness of the cowl portion 23 can be improved. Therefore, the cowl portion 23 can be easily configured to have a structure designed to absorb the collision energy effectively. Therefore, for example, even in a case where a pedestrian's head collides with the cowl portion 23, the impact received by the pedestrian's head can be reduced.

In addition, in a case where the dash panel portion 22 and the cowl portion 23 are manufactured by die-casting, the roll rigidity of the vehicle body component can be improved, and the roll rigidity of the entirety of the vehicle body structure 100 can be improved.

In addition, in a case where the vehicle body front portion 10 is manufactured by die-casting, the roll rigidity of the vehicle body front portion 10 can be improved, and the roll rigidity of the entirety of the vehicle body structure 100 can be improved.

Although the vehicle body structure according to the embodiment has been described above, the present disclosure can be changed as appropriate without departing from the scope of the disclosure.

For example, in the above-described embodiment, although the vehicle body component 20 in which the dash panel portion 22, the cowl portion 23, and the air conditioning device 30 are modularized has been described, the vehicle body component may include other parts. For example, the vehicle body component may be modularized to include a brake pedal, an electronic control unit (ECU), a silencer, and the like in addition to the above parts.

In the above embodiment, although an example has been described in which the vehicle body front portion 10 is manufactured by die-casting in which respective portions are integrated, the present disclosure is not limited to this. For example, the vehicle body front portion 10 may be manufactured by manufacturing respective portions as separate bodies via sheet-metal processing and then connecting the portions by welding or the like.

What is claimed is:

1. A vehicle body structure comprising:
a vehicle body front portion; and
a vehicle body component that includes a dash panel portion configured to separate a vehicle cabin from a front compartment and a cowl portion provided integrally with the dash panel portion on an upper side of the dash panel portion in a vehicle up-down direction, the vehicle body component being attached to the vehicle body front portion.

2. The vehicle body structure according to claim 1, wherein the vehicle body component is made of resin.

3. The vehicle body structure according to claim 1, wherein the vehicle body component is manufactured by die-casting.

4. The vehicle body structure according to claim 1, wherein the vehicle body front portion is manufactured by die-casting.
